(19) United States
(12) Patent Application Publication
(10) Pub. No.: US 2024/0094715 A1
(43) Pub. Date: Mar. 21, 2024

(54) Method of Material Flow Optimization

(71) Applicant: ABB Schweiz AG, Baden (CH)

(72) Inventors: Rickard Lindkvist, Västerås (SE); Jonas Linder, Mellerud (SE); Kalpesh Bhalodi, Zwingenberg (DE); Prerna Juhlin, Heidelberg (DE); Jan-Christoph Schlake, Darmstadt (DE); Dennis Janka, Heidelberg (DE); Andreas Potschka, Goslar (DE)

(21) Appl. No.: 18/263,371

(22) PCT Filed: Jan. 29, 2021
(86) PCT No.: PCT/EP2021/052140

§ 371 Date: Jul. 28, 2023

(51) Int. Cl. G05B 19/418

(52) U.S. Cl. CPC G05B 19/41865; G05B 2219/31376

(57) ABSTRACT

A method of material flow optimization in an industrial process by using an integrated optimizing system is described. The integrated optimizing system includes: a high-level optimizer module describing the material flow by coarse high-level process parameters and including an optimization program for the high-level process parameters, the optimization program being dependent on high-level model parameters and including an objective function subject to constraints; a low-level simulation module for simulating the material flow, the low-level simulation module including a low-level simulation function adapted for obtaining detailed low-level material flow data based on the high-level process parameters; and an aggregator module including an aggregator function adapted for calculating the high-level model parameters based on the low-level material flow data. The method includes approaching an optimum value of the objective function by iteratively modifying the high-level process parameters, wherein an iteration includes: carrying out, by the low-level simulation module, a low-level simulation thereby obtaining the detailed low-level material flow data; aggregating, by the aggregator module, the low-level material flow data thereby calculating, from the low-level material flow data, aggregated high-level model parameters; inputting the aggregated high-level model parameters into the optimization program.

### TECHNICAL FIELD

The present disclosure relates to a method of material flow optimization. Embodiments relate to an integrated optimizing system for material flow optimization.

### TECHNICAL BACKGROUND

In many industrial areas, simulation codes are available that can deliver high-fidelity predictions of the future dynamics of complex systems, e.g. of the material flow in a production process. Such simulations are already used heavily in order to improve the system with respect to prescribed objectives, e.g., safety, efficiency, or environmental impact. Improvements to the system are often derived manually in a trial and error fashion.

In principle, optimization methods offer a systematic approach to improvement tasks, e.g., Mixed-Integer Linear Programming (MILP) formulations. However, these methods cannot be applied readily to complex systems due to a lack of information/data as well as nonlinear and discontinuous effects. Instead, reduced models must be derived, e.g., by linearization and averaging, in order to leverage the power of MILP techniques, at the expense of a loss of prediction power. As a result, the derived system inputs are optimal for the reduced models, but not necessarily for the real-world system.

### SUMMARY

It is therefore an object of the present disclosure to overcome at least some of the above-mentioned problems at least partially.

In view of the above, a method of material flow optimization in an industrial process by using an integrated optimizing system is provided. The integrated optimizing system includes: a high-level optimizer module describing the material flow by coarse high-level process parameters x and including an optimization program for the high-level process parameters x, the optimization program being dependent on high-level model parameters A, b, c and including an objective function subject to constraints; a low-level simulation module for simulating the material flow, the low-level simulation module including a low-level simulation function adapted for obtaining detailed low-level material flow data F based on the high-level process parameters x; and an aggregator module including an aggregator function adapted for calculating the high-level model parameters A, b, c based on the low-level material flow data F. The method includes approaching an optimum value of the objective function by iteratively modifying the high-level process parameters x, wherein an iteration includes: carrying out, by the low-level simulation module, a low-level simulation thereby obtaining the detailed low-level material flow data F; aggregating, by the aggregator module, the low-level material flow data F thereby calculating, from the low-level material flow data F, aggregated high-level model parameters f_{A}, f_{b}, f_{c}, inputting the aggregated high-level model parameters f_{A}, f_{b}, f_{c} into the optimization program. Here, parameter indications such as F, x, A, b, c, f_{A}, f_{b}, f_{c} are mentioned only for illustration purposes.

Also, an integrated optimizing system for material flow optimization according to the features of claim 12 is provided.

Further advantages, features, aspects and details that can be combined with embodiments described herein are evident from the dependent claims, claim combinations, the description and the drawings.

### BRIEF DESCRIPTION OF THE FIGURES

The details will be described in the following with reference to the figures, wherein

FIG. 1 is a chart illustrating a method of material flow optimization according to aspects of the present disclosure;

FIG. 2 is a schematic illustration of an industrial process being modeled in the context of a method of material flow optimization according to aspects of the present disclosure;

FIG. 3 is a flow chart illustrating a method of material flow optimization according to aspects of the present disclosure;

FIG. 4 is a flow chart illustrating a method of material flow optimization according to aspects of the present disclosure;

FIG. 5 is a schematic illustration of an industrial process being modeled in the context of a method of material flow optimization according to aspects of the present disclosure;

FIG. 6 shows charts illustrating a relaxed solution of an optimization program according to aspects of the present disclosure;

FIG. 7 shows charts illustrating solutions of an optimization program according to aspects of the present disclosure; and

FIG. 8 shows charts illustrating solutions of an optimization program according to aspects of the present disclosure.

### DETAILED DESCRIPTION OF THE FIGURES

Reference will now be made in detail to the various embodiments, one or more examples of which are illustrated in each figure. Each example is provided by way of explanation and is not meant as a limitation. For example, features illustrated or described as part of one embodiment can be used on or in conjunction with any other embodiment to yield yet a further embodiment. It is intended that the present disclosure includes such modifications and variations.

Within the following description of the drawings, the same reference numbers refer to the same or to similar components. Generally, only the differences with respect to the individual embodiments are described. Unless specified otherwise, the description of a part or aspect in one embodiment can be applied to a corresponding part or aspect in another embodiment as well.

The present disclosure provides methods of coupling a high-fidelity simulation code (low-level simulation function) with a low-fidelity optimizer (optimization program for high-level process parameters). The solution is based on coupling the simulation code and the optimizer via an aggregator code (aggregator function). The output of the simulation code is used as input to the aggregator code, which outputs the parameters for the optimizer. The output of the optimizer may be fed back into the simulation code, giving rise to a circular data dependency.

With methods according to the present disclosure, a systematic approach to improvement tasks can be provided. Integrating simulation aspects yields a holistic optimization method. It is an advantage that existing simulation code may be used to perform an optimization. Reusability of the low-level, detailed simulation code for the high-level, coarser optimization program is highly beneficial because trusted products exist, often containing a substantial amount of concentrated expertise.

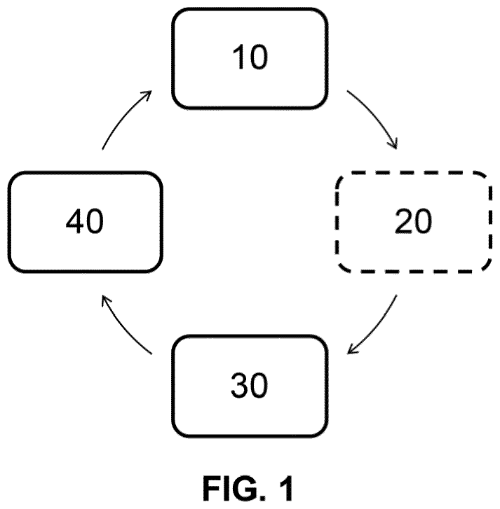

FIG. 1 is a chart illustrating a method of material flow optimization according to aspects of the present disclosure. The method is a method of material flow optimization in an industrial process by using an integrated optimizing system.

The integrated optimizing system includes a high-level optimizer module 10 describing the material flow by coarse high-level process parameters x and including an optimization program for the high-level process parameters x, the optimization program includes an objective function subject to constraints. Herein, the constraints are included in the term optimization program. The optimization program is dependent on high-level model parameters A, b, c.

The integrated optimizing system further includes a low-level simulation module 30 for simulating the material flow, the low-level simulation module 30 including a low-level simulation function adapted for obtaining detailed low-level material flow data F based on the high-level process parameters x. In particular, the low-level material flow data F is consistent with the high-level process parameters x.

The low-level simulation module may provide soft sensor capabilities. In particular, any of the following may be provided by the low-level simulation module: estimated values of unmeasured parameters or predicted future values of measured parameters. While using a low-level simulation module may require more time to calculate results, its capability to predict future values of parameters can substantially increase the accuracy of calculated process parameters, as compared to a sole use of an optimization module.

Optionally, a disaggregator 20 may be provided for receiving the high-level process parameters x and determining, based on the high-level process parameters x, low-level process parameters for the low-level simulation function. The disaggregator determines more detailed low-level process parameters consistent with the high-level process parameters x, based on a heuristic algorithm and/or on a low-level optimization routine.

The integrated optimizing system further includes an aggregator module 40 including an aggregator function adapted for calculating the high-level model parameters A, b, c based on the low-level material flow data F.

In the context of the present disclosure, the expression “high level” is particularly to be understood as indicating any of: fewer degrees of freedom describing a process, a coarse time scale, or linearized modeling functions. According to certain aspects of the disclosure, a high-level optimizer module can also consider nonlinearities like binary decision functions. For example, a decision if an additional conveyor belt should be used for transport of a material could be considered. Generally, high-level optimizer module may be less accurate and cover less short-term effects than low-level simulation modules.

In the context of the present disclosure, the expression “low level” is particularly to be understood as indicating any of: more degrees of freedom describing a process, a fine-grained time scale, or non-linear modeling functions.

Thus, a difference between the high-level parameters and the low-level data is that the high-level parameters have fewer degree of freedom (are used in a coarser model of the process) than the low-level data. The aggregator function a can therefore also be described as a projection function receiving the more detailed (more degrees of freedom) low-level material flow data and determining therefrom (projecting them onto) the corresponding coarser (less degrees of freedom) high-level parameters.

The method includes approaching an optimum value of the objective function by iteratively modifying the high-level process parameters x, i.e., finding the optimum process parameters x optimizing the objective function. The optimum value of the objective function may be a maximum or a minimum value.

An iteration includes carrying out, by the low-level simulation module, a low-level simulation, thereby obtaining the detailed low-level material flow data F. The input to the low-level simulation may be process conditions based on which the simulation is carried out. The process conditions may be process parameters fully specifying the process to be simulated, or more coarse conditions according to which process parameters are determined, e.g., by a low-level heuristic (e.g., partial optimization) routine. These input process conditions may be, for example, random or predefined initial process conditions or, for later iterations, process conditions based on the output from the high-level optimization of the previous iteration (see below).

The iteration further includes aggregating, by the aggregator module, the low-level material flow data F, thereby calculating, from the low-level material flow data F, aggregated high-level model parameters f_{A}, f_{b}, f_{c}. The iteration further includes inputting the aggregated high-level model parameters f_{A}, f_{b}, f. into the optimization program. If a designates the aggregator function, then the aggregated high-level model parameters can be described as f_{A}=a_{A}(F), f_{b}=a_{b}(F), f_{c}=a_{c}(F).

An optimization program, as described herein may also be called an optimization problem. In particular, the optimization program includes an objective function to be optimized over x, subject to constraints included in the optimization program. The objective function may include a penalty function. A penalty function is particularly to be understood as a term added to an objective function, the term including a penalty parameter multiplied by a measure of properties of the solution that are to be penalized, such as violation of constraints. The penalty function may also be called penalty term.

If we assume for simplicity that finding an optimal equates to finding a minimum, optimizing over x may be understood as finding a series of x that approaches the minimum. An optimum can likewise also be a maximum. The objective function may depend on further variables other than x, and may be optimized for at least some of the other variables as well. For example, the objective function can be the model objective function of the high-level model, or a derived function with additional terms and dependencies, e.g. including a penalty function. The objective function may be minimized both with respect to x and with respect to further variables. Additionally or alternatively, the high-level process parameters may include proxy process parameters \tilde{x} iteratively approaching the high-level process parameters x.

According to an aspect of the present disclosure, the low-level simulation may be carried out based on high-level process parameters including process parameters x obtained in a previous iteration. The process parameters x may be included directly into the low-level simulation, or may optionally be disaggregated for obtaining suitable low-level process parameters used for the low-level simulation.

The proxy process parameters \tilde{x} are further input parameters of the optimization program. In particular, the objective function includes a proxy process parameter penalty term penalizing a deviation between the proxy process parameters \tilde{x} and the high-level process parameters x. More particularly, the proxy process parameter penalty term uses the L1 norm. The low-level simulation function may calculate, particularly serve to calculate, the low-level material flow data F based on the proxy process parameters \tilde{x}.

According to an aspect of the present disclosure, the low-level simulation function includes any of: a low-level optimization program or a disaggregation function. The low-level optimization program particularly includes an objective function to be optimized.

According to an aspect of the present disclosure, the low-level simulation includes a nonlinear model to the process parameters x. In other words, a dependence of the simulation function on at least one of the process parameters x can be nonlinear. According to an aspect of the present disclosure, the aggregator function maps the low-level material flow data F onto high-level model parameters f_{A}, f_{b}, f_{c}.

According to an aspect of the present disclosure, the optimization program uses, as the high-level model parameters A, b, c, respective aggregated high-level model parameters f_{A}(\tilde{x}), f_{b}(\tilde{x}), f_{c}(\tilde{x}) obtained in the aggregating step performed by the aggregator module.

Additionally or alternatively, the optimization program may use, as the high-level model parameters f_{A}(\tilde{x}), f_{b}(\tilde{x}), f_{c}(\tilde{x}), respective proxy model parameters Ã, \tilde{b}, \tilde{c} iteratively approaching the aggregated high-level model parameters f_{A}, f_{b}, f_{c}. The proxy model parameters Ã, \tilde{b}, \tilde{c} are further input parameters of the optimization program. In particular, the objective function includes a proxy model parameter penalty term penalizing a deviation between the proxy model parameters Ã, \tilde{b}, \tilde{c} and the high-level model parameters f_{A}, f_{b}, f_{c}. More particularly, the proxy model parameter penalty term uses the L1 norm.

According an aspect of the present disclosure, the objective function is

c^{T}x (1′),

subject to boundary conditions

Ax=b (2′),

wherein c, x are vectors of length n, b is a vector of length m, and A is an mxn matrix.

The optimization program may use, as the high-level model parameters A and c in expressions (1), (2) the aggregated high-level model parameters f_{A}(\tilde{x}), f_{c}(\tilde{x}) obtained in the aggregating step performed by the aggregator module.

Additionally, or alternatively, the optimization program may use, as the high-level model parameter b in expression (2), a proxy model parameter \tilde{b} iteratively approaching the aggregated high-level model parameter fb.

The objective function is linear, particularly piecewise linear, as a function of the high-level process parameters x. The objective function is linear, particularly piecewise linear, as a function of the high-level model parameters Ã, \tilde{b}, \tilde{c}. The objective function is linear, particularly piecewise linear, as a function of the proxy parameters Ã, \tilde{b}, \tilde{c}.

According to an aspect of the present disclosure, elements of a vector x of an optimization program may be integer variables, particularly positive integer variables. Likewise, elements of the vector x may be binary variables selected from 0 and 1. The proxy variables \tilde{x}, \tilde{b} are continuous variables. In particular, the proxy variables \tilde{x}. \tilde{b} are not integer variables.

According to an aspect of the present disclosure, an iteration of the method, particularly starting from the second iteration, includes: carrying out the low-level simulation based on the high-level process parameters x obtained by the previous high-level optimization, thereby obtaining the low-level material flow data F. The high-level process parameters x obtained by the previous high-level optimization may be understood as the high-level process parameters x provided in the previous iteration's step of inputting the aggregated high-level model parameters fA, fb, fb into the optimization program.

The method may further include: carrying out the high-level optimization based on the aggregated high-level model parameters f_{A}, f_{b}, f_{c} obtained by aggregating the low-level material flow data F obtained by the previous low-level simulation, thereby obtaining the high-level process parameters x. The previous low-level simulation is particularly to be understood as the present iteration's step of carrying out a low-level simulation.

According to an aspect of the present disclosure, the output of the low-level simulation module is used as input to the aggregator module. The aggregator module may output the high-level model parameters to be used in the high-level optimizer module as an input for the optimization.

The output of the high-level optimizer module, particularly the high-level process parameters, is then fed, particularly in the next iteration, as an input to the low-level simulation module. In particular, a circular data dependency is thereby used in an iterative solution for the optimum. The method may include additional intermediate steps of disaggregation and further optimization prior to feeding input to the low-level simulation module. The intermediate steps can be particularly beneficial if the input to the low-level simulation module has more degrees of freedom than the high-level process parameters. In particular, the integrated optimizing system can include a disaggregator module 40 including a disaggregator function.

According to an aspect of the present disclosure, the proxy process parameter penalty term and/or the proxy model parameter penalty term contains a penalty multiplier p. The method is particularly a penalty alternating directions method. The method may include defining the penalty multiplier p. The method may further include an inner iterative loop in which the optimum value of the objective function is approached by a high-level optimization code iteratively modifying the high-level process parameters x.

The method may further include an outer iterative loop in which the penalty multiplier p is modified depending on an optimizing criterion for the inner loop. For example, when the optimizing criterion for the inner loop is met, the penalty multiplier p may be increased. The penalty multiplier p is for example modified by a gradient-based optimization algorithm. In particular, the method runs the inner loop within the outer loop. More particularly, the method alternately runs the inner loop and the outer loop.

According to an aspect of the present disclosure, the method includes generating sensitivity data by an adjoint algorithmic differentiation analysis step.

An exemplary optimization module according to aspects described herein can yield optimal medium decisions based on average flows with a time resolution of work shifts. In this case the decision variables are binary truck dispatch indicators, binary order acceptances, or continuous processor flow rates.

It is common that a resulting optimization problem is a mixed-integer linear programming (MILP) problem, which can be written in standard form as

min c^{T}x over x∈ [symbol] ⁿ

subject to Ax=b∈ [symbol] ^{m},

x≥b∈ [symbol] ^{m},

xᵢ∈{0, 1} f or i∈I. (1)

Here, the variables x include decision variables as well as system state variables (such as material flows). c∈ [symbol] ⁿ denotes the coefficients of the linear objective function. The equality constraints Ax=b encode mass conservation and component couplings. I⊂{1, . . . , n} includes the indices of binary decision variables within the vector x.

The MILP input data (A, b, c) is usually based on historical data aggregated into shift-averaged values. Conventionally, it is a modelling assumption that (A, b, c) do not depend on the decision variables x. This assumption, however, is a gross simplification, motivated by the desire to use MILP-technology for the practical solution of problem (1). In fact, there is a dependence of (A, b, c) on the decision variables in x.

We assume that we have a simulation model that maps decision variables x onto predictions F(x) for the material flow data (instead of historical data). We assume here that F: [symbol] ⁿ→ [symbol] ^{d} is continuous and piecewise differentiable, but must be treated as a black-box model that admits only lightly invasive modifications. Furthermore, we assume that we can aggregate the material flow data F(x) into MILP input data via another differentiable function a: [symbol] ^{d}→ [symbol] ^{m×n}× [symbol] ^{m}× [symbol] ⁿ. We denote the composition of prediction and aggregation by f=a∘f: [symbol] ⁿ→ [symbol] ^{m×n}× [symbol] ^{m}× [symbol] ⁿ. We refer to the components of f by indices A, b, c, resulting in f(x)=(f_{A}(x), f_{b}(x), f_{c}(x)), which could serve as input data to problem (1). This gives rise to a circular data dependency as depicted in FIG. 1.

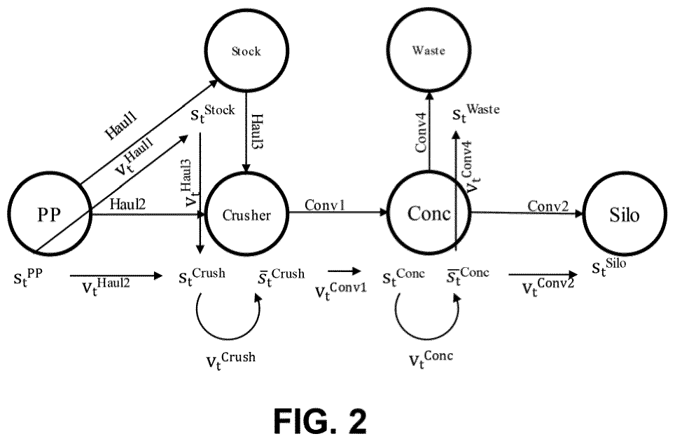

FIG. 2 illustrates schematically of an industrial process being modeled in the context of a method of material flow optimization described herein. The figure is a diagram representing the low-level simulation of the industrial process. The industrial process includes various stages (here from left to right: PP as the process beginning, a Crusher, a Concentrator, and a final storage silo, with Stocks and Waste production modelled as shown in FIG. 2). FIG. 2 also shows parameters representing the material and material flow at and between these stages, such as parameters v representing respective material flow rates between the process stages and s representing amounts of material at the process stages. These parameters are linked to each other according to the low-level simulation model illustrated in FIG. 2, so that for example the material flow rates are matched with respective changes in the amounts of material per time interval.

Next, a particular implementation of the method according to an aspect of the present disclosure is described.

Therein, the objective function is c^{T}x, subject to boundary conditions Ax=b, as described further above. c, x are vectors of length n, b is a vector of length m, and A is an mxn matrix. Thus, the optimization problem of Eq. (1) above, including a consideration of the predictions F, can then be stated as the coupled problem

min c^{T}x over x∈ [symbol] ⁿ (2)

subject to Ax=b,

x≥0,

xᵢ∈{0, 1} for i∈I,

(A, b, c)=f(x).

which can be written in slightly shorter form as

min f_{c}^{T}(x) over A∈( [symbol] )ⁿ (3)

subject to f_{A}(x)x=f_{b}(x),

x≥0,

xᵢ∈{0, 1} for i∈I.

This problem is a large-scale nonlinear non-smooth mixed-integer problem for which no solution methods exist. We propose to use an optimization heuristic in which one optimizes alternately over two subsets of variables until no further progress can be achieved. A goal would be to find a partitioning of the variables into two sets, such that each optimization step over only one subset of variables carries enough mathematical structure to allow for practical solution algorithms. For the background on a possible solution abbreviated as ADM, we refer the reader to S. Gottlich, F. M. Hante, A. Potschka and L. Schewe. Penalty alternating direction methods for mixed-integer optimal control with combinatorial constraints (2019). ArXiv:1905.13554.

However, the variables in problems (2) and (3) do not lend themselves readily to such partitioning. We therefore perform two more steps of reformulation: In the first step, we introduce additional variables without changing the solution to the problem. In the second step, we relax certain constraints by an 11-penalty approach.

The first step may be understood as lifting to higher dimensions. In the first step, we introduce a copy \tilde{x} of the decision variables x and a copy \tilde{b} of the MILP input data b. We can then write down the equivalent problem formulation

min f_{c}^{T}(\tilde{x})x over x,\tilde{x}∈ [symbol] ⁿ, \tilde{b}∈ [symbol] ^{m} (4)

subject to f_{A}(\tilde{x}x=\tilde{b},

x≥0,

xᵢ∈{0, 1} for i∈I,

\tilde{b}=f_{b}(\tilde{x}),

\tilde{x}=x.

In the context of the present disclosure, the introduced additional variables \tilde{x}, \tilde{b} are also called proxy parameters. In particular, \tilde{x} is termed a proxy process parameter and \tilde{b} a proxy model parameter. The introduction of the additional variables makes it possible to arrive at a useful formulation after the second step.

The second step may be understood as decoupling via a I1 penalty. We can now drop the last two constraints in (4) and enforce them only weakly via I1 penalty terms in the objective function. We choose the I1 norm, because it gives rise to an exact penalty function that is piecewise differentiable and because it can be modelled exactly with MILP techniques.

With some sufficiently large penalty parameter p>0, the resulting problem reads

min f_{c}^{T}(\tilde{x})x+ρ∥x−\tilde{x}∥₁+ρ∥\tilde{b}−f_{b}(\tilde{x})∥₁ (5)

over x, \tilde{x}∈ [symbol] ⁿ, \tilde{b}∈ [symbol] ^{m},

subject to f_{A}(\tilde{x})x=\tilde{b},

x≥0,

xᵢ∈{0, 1} for i∈I.

With this formulation, it is now possible to alternately optimize over x and over (\tilde{x}, \tilde{b}). For optimization in the direction of x, problem (5) is again a MILP and can be solved practically with MILP technology. In particular, the problem can be solved using the existing optimization code for problem (1), which only needs to be augmented by including the penalty term ρ∥x−\tilde{x}∥₁ in its objective function. The remaining term ρ∥\tilde{b}−f_{b}(\tilde{x}∥₁ in the penalty function of problem (5) does not depend on x.

For the optimization with respect to (\tilde{x}, \tilde{b}), it can be beneficial to eliminate \tilde{b}=fₐ(\tilde{x})x to arrive at the unconstrained continuous non-smooth nonlinear optimization problem

min f_{c}^{T}(\tilde{x})x+ρ∥x−\tilde{x}∥₁+ρ∥f_{A}(\tilde{x})x−f_{b}(\tilde{x})∥₁ (6)

over \tilde{x}∈ [symbol] ⁿ.

The introduction of \tilde{b} in problem (4) is necessary for arriving at an unconstrained problem in (6). To arrive at a continuous problem in (6), it is important that integrality is only enforced on the x variables in problem (4) but not on the \tilde{x} variables.

However, the prediction and aggregation functions f(x)=a(F(x)) must be able to produce meaningful results also for fractional realizations \tilde{x}, ∈[0,1] of the binary variables xᵢ, i∈I. The problem (6) might be unbounded from below for small ρ. The method may include carrying over bounds on the decision variables also to (6) and, particularly, using projected gradient descent.

Regarding solution methods for problem (6), the evaluation of the objective functions will be a concatenation of piecewise differentiable elemental functions, similar to the evaluation of Deep Neural Nets for example with ReLU units.

The method may include using the adjoint mode of algorithmic differentiation to compute at least one element of the subgradient of the objective function in problem (6). An element of the subgradient may thus be efficiently computed in less than for example five times the computational work required for a simple evaluation of the objective function. As additional benefits, this “automatic differentiation of the code” is usually much faster and much less error-prone than tedious symbolic differentiation by hand. Using the adjoint mode of Algorithmic Differentiation would be called back propagation in the terminology of Deep Learning.

The method may include using Deep Learning libraries like for example PyTorch for augmenting existing simulation codes (including, but not limited to, discrete-event simulation codes) with adjoint differentiation capabilities. Computed gradients could then be used in appropriate variants of steepest descent algorithms.

The method may include solving the problem (5) via a penalty alternating directions method (ADM) as described herein, particularly with ε-optimality, more particularly with partial ε-optimality. The penalty ADM is stated below for problem (5), using the variables introduced above. For the penalty ADM, we abbreviate

y=(\tilde{x},\tilde{b}) and Y= [symbol] ⁿ× [symbol] ^{m}.

We denote the objective function of problem (5) by

Ψ=(x,y) :=f_{c}^{T}(\tilde{x})x+ρ∥x−\tilde{x}∥₁+ρ∥\tilde{b}−f_{b}(\tilde{x})∥₁

and its feasible set for x by

X={x∈ [symbol] ⁿ|f_{A}(\tilde{x})x=b, x≥0,xᵢ∈{0, 1}, i∈I}.

A penalty ADM of solving problem (5) may be expressed as an algorithm as follows.

```
Algorithm 1
Choose (x^{(0,*)}, y^{(0,*)}) ∈ X × Y and ρ⁽¹⁾ > 0
for k = 1, 2, 3 . . . do
  Set (x^{(k,0)}, y^{(k,0)}) = (x^{(k-1,*)}, y^{(k-1,*)})
  for / = 0, 1, 2, . . . do
    $For {y}^{( k , l )} f ixed , find \frac{ε}{2} optimal solution {x}^{( k , i + 1 )} ∈ X of ( 5 ) , using a$
    MILP solver
    $if Ψ ( {x}^{( k , l + 1 )} , {y}^{( k , l )} ) \geq Ψ ( {x}^{( k , l )} , {y}^{( k , l )} ) - \frac{ε}{2} then$
      Set (x^{(k,*)}, y^{(k,*)}) = (x^{(k,l+1)}, y^{(k,l)})
      break
    end if
    $For {x}^{( k , l + 1 )} fixed , find \frac{ε}{2} optimal solution {y}^{( k , l + 1 )} ∈ Y of ( 6 )$
    $if Ψ ( {x}^{( k , l + 1 )} , {y}^{( k , l + 1 )} ) \geq Ψ ( {x}^{( k , l + 1 )} , {y}^{( k , l )} ) - \frac{ε}{2} then$
      Set (x^{(k,*)}, y^{(k,*)}) = (x^{(k,l)}, y^{(k,l)})
      break
    end if
  end for
  Choose ρ^{(k+1)} > ρ^{(k)}
end for
```

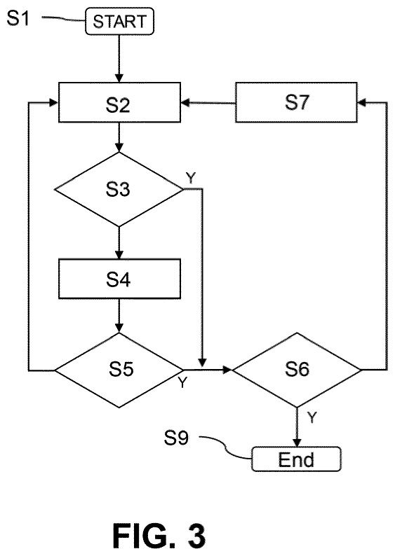

FIG. 3 is a chart illustrating a method of material flow optimization according to aspects of the present disclosure. In particular, the chart is a qualitative flowsheet representation of Algorithm 1 discussed above. The method starts in block S1. The method includes, in block S2, optimizing the objective function of problem (5) with respect to x, particularly via a MILP code.

The method includes, in block S3, evaluating if a partially optimal solution has been found. If the answer is yes, the method proceeds to block S6, where the decision if the method should be terminated is made. Otherwise, the method proceeds in block S4, where the objective function of problem (5) is optimized with respect to (\tilde{x}, \tilde{b}), particularly using algorithmic differentiation.

The method includes, in block S5, a further evaluation if a partially optimal solution has been found. If the answer is yes, the method proceeds to block S6, where the decision if the method should be terminated is made. Otherwise, the method goes back to block S2, where the objective function is evaluated again with respect x. If no partially optimal solution is found in blocks S3 or S5, the method keeps proceeding in an inner loop, alternating between an optimization with respect to x and an optimization with respect to (\tilde{x}, \tilde{b}).

If in block S6 no decision is made to terminate the method, it proceeds to block S7, where the penalty parameter p is increased. Block S7 is part of an outer loop for increasing the penalty. From block S7, the method returns to block S2, where the objective function is evaluated again with respect to x. If in block S6 the decision is made to terminate, the method proceeds to block S9, where it ends.

The present disclosure further relates to an integrated optimizing system for material flow optimization in an industrial process. The integrated optimizing system includes a high-level optimizer module describing the material flow by coarse high-level process parameters x and including an optimization program for the high-level process parameters x. The optimization program includes an objective function subject to constraints and being dependent on high-level model parameters A, b, c.

The integrated optimizing system further includes a low-level simulation module for simulating the material flow, the low-level simulation module including a low-level simulation function adapted for obtaining detailed low-level material flow data F based on the high-level process parameters x. In particular, the low-level material flow data is consistent with the high-level process parameters x. The low-level simulation module may additionally include a low-level optimization.

The integrated optimizing system further includes an aggregator module including an aggregator function adapted for calculating the high-level model parameters A, b, c based on the low-level material flow data F. The integrated optimizing system is configured for carrying out a method according to aspects described herein.

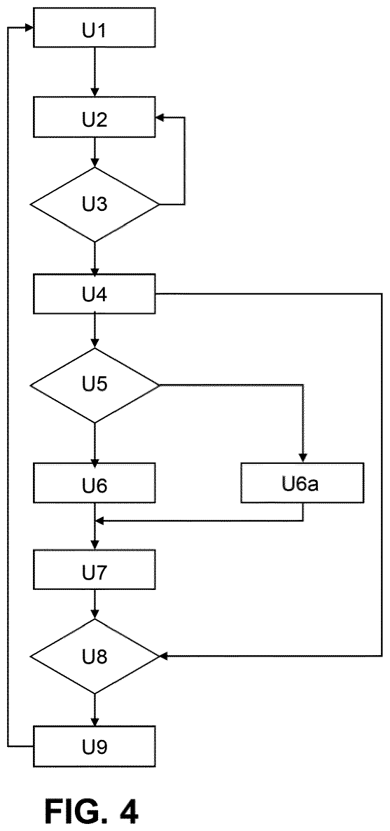

FIG. 4 is a chart illustrating a method of material flow optimization according to aspects of the present disclosure. The integrated optimizing system may include a user interface.

The method starts in block U1. The method may include, in block U2, presenting a current state of the mine. The method may include, in block U3, a determination if a process evaluation or correction is needed. If the answer is no, the method returns to block U2. Otherwise, the method proceeds with block U4, where a user, e.g. an operator, may choose among preconfigured or manually configured simulations or optimizations. In the following, references to the term “operator” can also be understood as referring to the term “user”.

In particular, the method may include: selecting, by an operator, a scenario from a plurality of predetermined scenarios presented by the user interface. Each of the predetermined scenarios include definitions of a plurality of model parameters belonging to the respective scenario. The method may include using the model parameters for the material flow optimization.

When the operator chooses one of the scenarios, the integrated optimizing system may execute the predefined configuration and present the results in one or more predefined configuration views. The predetermined scenarios may be fixed or configurable. As an example, the operator may choose a speed reduction of e.g. 10% for vehicles in a production area. In this example, all vehicles would automatically be configured with a 10% lower speed and the scenario would be simulated, particularly optimized according to aspects described herein.

The method may include, in block U5, determining if a precalculated simulation for a chosen scenario is available. The precalculated simulation data may be provided for example from a remote storage location, particularly from an Internet server. If no precalculated data are available, method may proceed to block U6a, where data a generated, for example via an optimization method as disclosed herein. From block U6 a as well as from block U5, the method proceeds to block U7, where the results, e.g. simulation results, are presented to the operator.

The method may further include: selecting, by an operator, a filter from a plurality of predetermined filters presented by the user interface, and using the selected filter for filtering the output of the material flow optimization.

The method may further include presenting, by the user interface, an advice proposing one or more preferred, particularly recommended, actions based on the material flow optimization. For example, the proposed actions may be based on key performance indicators (KPIs) for production.

From block U7, the method proceeds to block U8, where it is determined if a configuration based on the results presented in block U7, e.g. the simulation results, can be used in conjunction with the presently needed operation. If the answer is yes, the method proceeds to block U9, where the configuration is applied in operation. The method then returns to the start in block U1.

Generally, operators controlling an industrial process need to be able to monitor the process and to take preventive actions. To support this work efficiently an advisory solution can be used. A simulation engine is used to simulate the industrial process using a model including the process steps of interest. The results may be displayed for the operator on the user interface who can immediately act or for example test and compare different scenarios.

Operators frequently want to compare the same scenarios, i.e. a limited number of different scenarios. With predetermined user interfaces, particularly predefined human-machine interfaces (HMIs), and configurations according to the present disclosure, a particularly fast and easy interaction of the operator with the system may be achieved. Repeatable solutions may be provided to operators. In particular, the results are presented in a clear and consistent format. Output may be particularly easy to interpret, such that the operator receives advice which can be used immediately.

When simulating different scenarios, it is cumbersome to change all variables that affect the process and particularly to evaluate all changes occurring to the output variables. Repeatedly simulating different scenarios, particularly in a systematic way and many times per shift, may pose certain challenges. For example, the operator may be monitoring a process, e.g. a mining material flow process. During normal operation, the operator wants to evaluate the sensitivity of the plant to make sure that the process is kept within limits. If a problem, unplanned event or deviation is observed, the operator may be under stress and needs to decide fast to get the process back on track. Operators typically have to perform fast evaluations of the process status periodically and/or under stress.

User interfaces according aspects of the present disclosure may include at least one of a first, second, or third interface. The first interface in particularly an input interface with at least one predefined or configurable scenario. The second interface is particularly an output interface where the most relevant output results are presented, with one or more configurable filter alternative. The third interface is particularly an advisory interface where advice to the operator may be presented.

The operator can execute at least one input scenario and view an output result in a “filtered” predefined format, view the advice presented, or both. Accordingly, the operator receives fast updates on the sensitivity or impact of the process and can take relevant decision fast.

### Formulation of a Minimum Viable Scenario

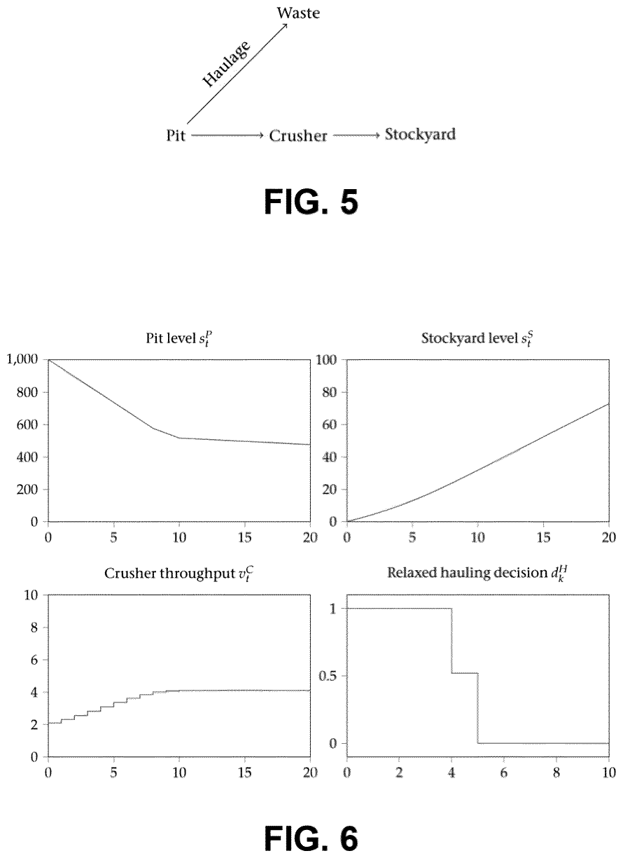

To address the main challenges of the coupling of a simulation module, like for example DESim, with a mixed-integer optimizer using a penalty alternating directions method (PADM), a simplified problem statement without the direct use of DESim can be employed. To still address the issues of combining mixed-integer decisions, nonlinearities, and attribute tracking, an exemplary minimum viable scenario is provided below. A schematic illustration of the industrial process being modeled is depicted in FIG. 5. A crusher can directly pick up material from a pit, process it, and deposit it to a stockyard. The material in the pit has an attribute that influences the crushing process. The initial material incurs higher processing CO2 emissions in the crusher. Haulage trucks can be used to transport material with higher processing emissions to the waste dump to lower the CO2 emissions. The deployment of trucks is a binary decision for each shift (yes/no), which lives on a coarser time discretization than the continuous crusher throughput control. The objective is to maximize the amount of material at the stockyard at the end of the considered time horizon while keeping the CO2 emissions below a given threshold.

To settle our notation, we use a discrete-time model on an equidistant time-grid t=0, . . . , 20=: n with a coarser supergrid that combines m=2 intervals into one interval (assuming that m is a divisor of n). The storage levels are denoted by sₜ^{P}, sₜ^{S}, sₜ^{W} for the pit, stockyard, and waste dump, respectively. The binary haulage decision is dₓ^{H}∈{0, 1} with k=└t2┘. The haulage throughput is v^{H}=50 and the crusher throughput is vₜ^{C}, subject to the lower bound 0 and the upper bound 10. As initial conditions, we assume s₀^{P}=1000, s₀^{S}=0, s₀^{W}=0. The upper bound on the crusher CO2 emissions e^{c} is e^{max}=150.

For the sake of simplicity, we disregard the CO2 emissions of the truck haulage. The crusher CO2 emissions are assumed to depend quadratically on the crusher throughput with a factor that depends on the material attribute σ.

Furthermore, we assume that the material attribute is shaped as a parabola depending only on the storage level of the pit according to

$$σ ( {s}_{i}^{P} ) = \frac{1}{2} + 2 {( \frac{{s}_{i}^{P}}{1000} - \frac{1}{2} )}^{2} ,$$

which means that σ(s₉^{S})=σ(O)=1 and attains its minimum when the pit has been half emptied σ(500)=1/2 .

Together with the linear dynamics and the emission formula, the resulting Mixed-Integer linear Program (MINLP) reads as

$$min - {s}_{n}^{S} \qquad ( 1 )$$

$$s . t .$$

$${s}_{i + 1}^{P} = {s}_{i}^{P} - {v}_{t}^{C} - {v}^{H} {d}_{[ lim ]}^{H} ,$$

$${s}_{i + 1}^{S} = {s}_{t}^{S} + {v}_{t}^{C} ,$$

$${s}_{i + 1}^{W} = {s}_{i}^{W} + {v}^{H} {d}_{[ lim ]}^{H} ,$$

$${s}^{P} = 1000 ,$$

$${s}^{S} = 0 ,$$

$${s}^{W} = 0 ,$$

$${e}^{C} = {\sum }_{i = 0}^{n - 1} σ ( {s}_{i}^{P} ) \cdot {( {v}_{t}^{C} )}^{2} ,$$

$${e}^{C} \leq {e}^{max} ,$$

$$0 \leq {v}_{i}^{C} \leq 10 ,$$

$${d}_{t}^{H} ∈ \{ 0 , 1 \} ,$$

where t runs from 0 to n−1 in the dynamics.

To get an idea of the optimal solution, we relax the integer constraint to dₜ^{H}∈[0, 1] and use the software library 1popt to solve the resulting NLP set up with the software framework CasADi. The resulting solution is depicted in FIG. 6. We can observe that the optimal relaxed hauling decision dkH is already almost integer except for k=4, which would probably have to be rounded up or down and fed back to reoptimize (1) over the continuous controls vtc only to obtain an optimal solution. It is apparently optimal to move away much of the initial CO2-intensive material to the waste dump and then mainly process the material that lies around the level sₜ^{P}=500 where the CO2 emissions for processing are minimal.

For this simplified scenario, it turned out to be easier to use CasADi for the computation of derivatives and the coupling to the NLP solver Ipopt. Previously, we had suggested that a gradient-type method should be used to solve the resulting non-smooth unconstrained problem, which is possible in principle, but no reliable off-the-shelf solver is currently available.

### Penalty Alternating Directions Method

For the application of PADM, we first reformulate problem (1) in the variables x =(s^{P}, S^{S}, S^{W}, v^{C}, d^{H}, e^{C}), which implies that the objective is already of linear form c^{T}x for a suitably chosen vector c and the linear dynamics and initial values can be cast in a linear constraint Ax=b for some matrix A and right-hand side b.

The remaining application of PADM consists in a number of equivalent reformulations that are seemingly making the problem formulation more complex, but allow for a penalty decomposition later.

### Equivalent Reformulations

The first reformulation addresses the nonlinearities in the CO2 emissions constraint

$$E ( x ) = {\sum }_{t = 0}^{n - 1} σ ( {s}_{t}^{P} ) \cdot {( {v}_{t}^{C} )}^{2} \leq {e}^{max} .$$

Here, we linearize E(x) around some given point \tilde{x}, which yields

[symbol]

and

[symbol]

Obviously, we obtain Eₓ^{lin}=E(x) if we linearize at \tilde{x}=x and we can equivalently use the constraint Eₓ^{lin}(x)≤e^{max} instead of E(x)≤e^{max} in (1). This linearization will later happen in the aggregator, which generates the input data to the MILP optimizer. Together, we arrive at the equivalent problem

$${min}_{x} {c}^{T} x \qquad ( 2 )$$

$$s . t .$$

$$Ax = b ,$$

$${e}^{C} = E ( x ) + ∇ {E ( x )}^{T} ( x - x ) ,$$

$${e}^{C} = {e}^{max} ,$$

$$0 \leq {v}_{i}^{C} \leq 10 ,$$

$${d}_{t}^{H} ∈ \{ 0 , 1 \} .$$

The second equivalent reformulation duplicates the degrees of freedom x to

[symbol]

only to enforce they are the same by the constraint x−\tilde{x}=0. This allows us to judiciously choose from which set of variables we pick the arguments of the occurring functions. The choice

[symbol]

is beneficial for the CO2 emission constraint. Together, we arrive at the equivalent problem

$${min}_{x , \tilde{x}} {c}^{T} x \qquad ( 3 )$$

$$s . t .$$

$$Ax = b ,$$

$${e}^{C} - ∇ {E ( \tilde{x} )}^{T} x = E ( \tilde{x} ) - ∇ {E ( \tilde{x} )}^{T} \tilde{x} ,$$

$${e}^{C} \leq {e}^{max} ,$$

$$0 \leq {v}_{i}^{C} \leq 10 ,$$

$${d}_{t}^{H} ∈ \{ 0 , 1 \} ,$$

$$x - \tilde{x} = 0.$$

The third equivalent reformulation introduces another constrained variable

[symbol]

and we end up with

$${min}_{x , y} {c}^{T} x \qquad ( 4 )$$

$$s . t .$$

$$Ax = b ,$$

$${e}^{C} - ∇ {E ( \tilde{x} )}^{T} x = \tilde{b} ,$$

$${e}^{C} \leq {e}^{max} ,$$

$$0 \leq {v}_{i}^{C} \leq 10 ,$$

$${d}_{t}^{H} ∈ \{ 0 , 1 \} ,$$

$$x - \tilde{x} = 0 ,$$

$$E ( \tilde{x} ) - ∇ {E ( \tilde{x} )}^{T} \tilde{x} - \tilde{b} = 0 ,$$

where we use y=(\tilde{x}, \tilde{b}).

### Penalty Decoupling

We now relax problem (4) by enforcing the last two constraints only weakly by an I1-penalty term weighted with the penalty parameter ρ≥0, which leads to

$${min}_{x , y} {c}^{T} x + ρ {‖ x - \tilde{x} ‖}_{1} + ρ {‖ E ( \tilde{x} ) - ∇ {E ( \tilde{x} )}^{T} \tilde{x} - \tilde{b} ‖}_{1} \qquad ( 5 )$$

$$s . t .$$

$$Ax = b ,$$

$${e}^{C} - ∇ {E ( \tilde{x} )}^{T} x = \tilde{b} ,$$

$${e}^{C} \leq {e}^{max} ,$$

$$0 \leq {v}_{i}^{C} \leq 10 ,$$

$${d}_{t}^{H} ∈ \{ 0 , 1 \} .$$

The crucial observation now is that we obtain a substantial amount of mathematical structure if we alternately optimize over x and y.

Optimize over x. If we fix y and optimize over x, we obtain an MILP (the I1-term ∥x−\tilde{x}∥₁ can be reformulated using slacks and the second I1-term is just a constant). This problem can be solved efficiently with established linear programming technology as provided, e.g., by optimization solver Gurobi.

Optimize over y. If we fix x and optimize over y, we can eliminate \tilde{b} to arrive at the unconstrained non-smooth optimization problem

$${min}_{\tilde{x}} {c}^{T} x + ρ {‖ x - \tilde{x} ‖}_{1} + ρ {‖ E ( \tilde{x} ) - {e}^{C} + ∇ {E ( \tilde{x} )}^{T} ( x - \tilde{x} ) ‖}_{1} , \qquad ( 6 )$$

This problem can be solved with methods based on gradient descent or reformulated into an NLP using slack variables.

It is important to note here that in case there are more than one nonlinear constraints, e.g., due to nonlinearities in the dynamics, the dimension of \tilde{b} would increase to, say, p∈ [symbol] . Reformulating (6) with slacks would require the evaluation of p gradients with p backward AD sweeps, while a (sub)gradient of the objective function of (6) could still be obtained by just one backward AD sweep.

As a side remark, we can also add the constraints

[symbol]

in problems (3)-(6), which preserves the equivalence of the reformulations, but adds box constraints to some of the variables in (6), which could be handled with projected gradient methods.

### Partial Minima are not Guaranteed to be Optimal

In general, optimizing in alternating directions does not guarantee convergence to an optimum of (5). In fact, the algorithm can get stuck in points where no improvement is possible in either direction by itself. These points are called partial minima and they indeed occur, as we see below.

### Implicit and Explicit Variables

The general PADM framework delivers a substantial amount of freedom on how to choose E(x), because the variables x can be split into explicit variables vc and d^{H} and implicit variables, which are fully determined by the explicit variables through the process dynamics and initial values. Thus, it is in principle possible to not use the implicit variables as degrees of freedom in the optimization problems (1)-(4). This choice has a drastic effect on problem (6). In the above derivation, we do not have to resort to the simulator at all for the optimization of (6), while if we drop the implicit variables, the evaluation of E and ΔE requires a forward simulation sweep and already a first order derivative. Descent methods based on gradients would either have to resort to higher order derivatives (which is difficult in PyTorch) or to hand-written expressions for ∇E.

### Simulator, Aggregator, and Optimizer

The role of DESim is now substituted with a simple forward sweep through the dynamics and the CO2 emissions. Its inputs are the crusher throughput vtc and the hauling decisions dₖ^{H}.

The aggregator linearizes E(\tilde{x}) at \tilde{x}, which provides the input matrix and vector data to the MILP optimizer. It is repeatedly called and needs to be differentiated for the optimization with respect to y=(\tilde{x}, \tilde{b}.

The MILP optimizer optimizes over x and ensures integer feasibility of the solution.

### Numerical Results

We use a simplified PADM method with an outer loop and an inner loop. In the outer loop, we increase the penalty parameter ρ from 0.1 to 1,000 in multiples of 10. In the inner loop, we just do three rounds of alternately optimizing over y and then x. More refined flow control and termination criteria are possible (see S. Göttlich, F. M. Hante, A. Potschka and L. Schewe. Penalty alternating direction methods for mixed-integer optimal control with combinatorial constraints (2019). ArXiv:1905.13554) but were not implemented here.

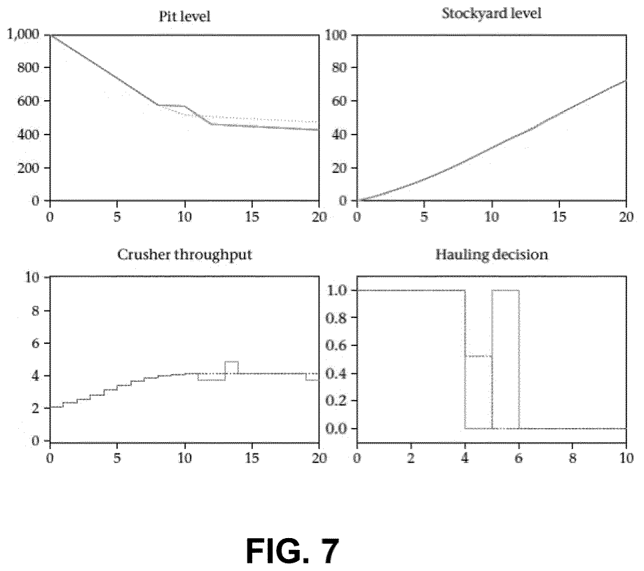

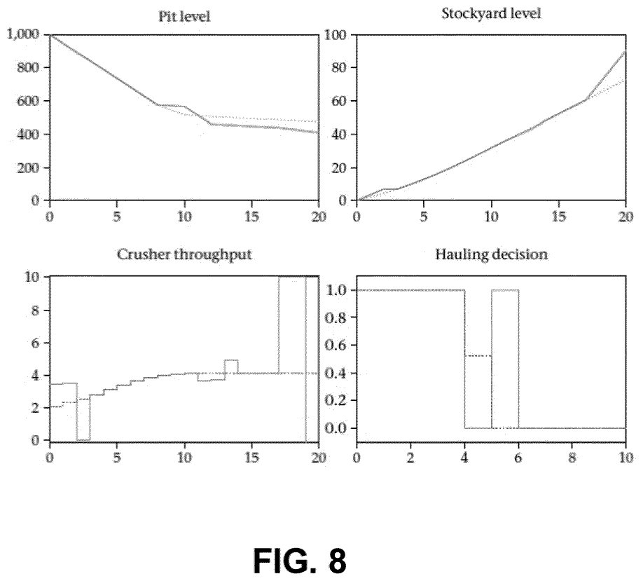

As an initial guess, we used the relaxed solution depicted in FIG. 6 and perturbed v^{c} by scaling it with a value of α0∈(0, 1). The result of the PADM approach for the choices of α0=0.91 and α0=0.90 are depicted in FIGS. 7 and 8, respectively.

In particular, FIG. 7 shows the PADM result for an initial guess generated from the relaxed solution (dotted red) with scaling α0=0.91. The NLP solution is displayed in solid orange, the MILP solution in solid blue. The value of e^{c} (not shown) converges to e^{max}. FIG. 8 shows the PADM result for an initial guess generated from the relaxed solution (dotted red) with scaling α0=0.90. The NLP solution is displayed in solid orange, the MILP solution in solid blue. The final value of e^{C} (not shown) is 287,4, which is much greater than e^{max}.

While both approaches satisfy integrality of d^{H}, the one started with α0=0.91 also satisfies the nonlinear CO2 emission constraint. When started from an initial guess generated with α0=0.90, the PADM does not converge to a partial minimum that satisfies the CO2 emission constraint. In fact, it is largely violated and the two controls vₙ^{H} and \tilde{v}ₙ^{H} do not coincide on the last interval.

The method according to the present invention is applicable to any industrial process, and not limited to particular kinds of industrial process. Particularly suitable industrial processes are processes including a material flow, especially the flow of a bulk material which is represented as a continuous flow. This includes, in particular, material extraction and material processing industries, and especially particular continuous material extraction and continuous material processing. Examples are mining, paper and pulp, metals processing, polymer processing, and chemical processing of materials. Further examples are cement, food, or beverage processing, as well as transportation processes, particularly including the charging of electric vehicles.

1. A method of material flow optimization in an industrial process by using an integrated optimizing system,
the integrated optimizing system comprising:
a high-level optimizer module describing the material flow by coarse high-level process parameters (x) and including an optimization program for the high-level process parameters (x), the optimization program being dependent on high-level model parameters (A, b, c) and including an objective function subject to constraints;
a low-level simulation module for simulating the material flow, the low-level simulation module including a low-level simulation function adapted for obtaining detailed low-level material flow data (F) based on the high-level process parameters (x); and
an aggregator module including an aggregator function adapted for calculating the high-level model parameters (A, b, c) based on the low-level material flow data (F),
the method including approaching an optimum value of the objective function by iteratively modifying the high-level process parameters (x), wherein an iteration includes:
a) carrying out, by the low-level simulation module, a low-level simulation thereby obtaining the detailed low-level material flow data (F);
b) aggregating, by the aggregator module, the low-level material flow data (F) thereby calculating, from the low-level material flow data (F), aggregated high-level model parameters (f_{A}, f_{b}, f_{c}); and
c) inputting the aggregated high-level model parameters (f_{A}, f_{b}, f_{c}) into the optimization program.

2. The method of material flow optimization according to claim 1, wherein the low-level simulation is carried out based on high-level process parameters selected from the following:
process parameters (x) obtained in a previous iteration, or
proxy process parameters (\tilde{x}) iteratively approaching the high-level process parameters (x), wherein
the proxy process parameters (\tilde{x}) are further input parameters of the optimization program, and wherein
the objective function includes a proxy process parameter penalty term penalizing a deviation between the proxy process parameters (\tilde{x}) and the high-level process parameters (x).

3. The method of material flow optimization according to claim 1, wherein the low-level simulation includes a nonlinear model for the process parameters (x).

4. The method of material flow optimization according to claim 1, wherein
the aggregator function maps the low-level material flow data (F) onto high-level model parameters (f_{A}, f_{b}, f_{c}).

5. The method of material flow optimization according to claim 1, wherein
the optimization program uses, as the high-level model parameters (A, b, c), respective parameters selected from the following:
the aggregated high-level model parameters (f_{A}(\tilde{x}), f_{b}(\tilde{x}), f_{c}(\tilde{x})) obtained in step b), or
proxy model parameters (Ã, \tilde{b}, \tilde{c}) iteratively approaching the aggregated high-level model parameters (f_{A}, f_{b}, f_{c}), wherein
the proxy model parameters (Ã, \tilde{b}, \tilde{c}) are further input parameters of the optimization program, and wherein
the objective function includes a proxy model parameter penalty term penalizing a deviation between the proxy model parameters (Ã, \tilde{b}, \tilde{c}) and the high-level model parameters (f_{A}, f_{b}, f_{c}).

6. The method of material flow optimization according to claim 1, wherein the objective function is a function
c^{T}x (1),
subject to boundary conditions Ax=b (2),
wherein c, x are vectors of length n, b is a vector of length m, and A is an m×n matrix.

7. The method of material flow optimization according to claim 6, wherein
the optimization program uses, as the high-level model parameters A and c in expressions (1), (2) the aggregated high-level model parameters (f_{A}(\tilde{x}), f_{c}(\tilde{x}) obtained in step b.

8. Method of material flow optimization according to claim 1, wherein an iteration of the method includes
a) carrying out the low-level simulation based on the high-level process parameters (x) obtained by the previous high-level optimization, thereby obtaining the low-level material flow data (F); and
c) carrying out a high-level optimization based on the aggregated high-level model parameters (f_{A}, f_{b}, f_{c}) obtained by aggregating the low-level material flow data (F) obtained by the previous low-level simulation, thereby obtaining the high-level process parameters (x).

9. The method of material flow optimization according to claim 1, wherein
the output of the low-level simulation module is used as input to the aggregator module, which outputs the high-level model parameters to be used in the high-level optimizer module as an input for the optimization; and wherein
the output of the high-level optimizer module is then fed as an input to the low-level simulation module.

10. The method of material flow optimization according to claim 1, wherein
one or more selected from the group consisting of
the proxy process parameter penalty term and
the proxy model parameter penalty term
contains a penalty multiplier ρ, and wherein
the method comprises:
i) defining a penalty multiplier p;
ii) an inner iterative loop in which the optimum value of the objective function is approached by a high-level optimization code iteratively modifying the high-level process parameters (x); and
iii) an outer iterative loop in which the penalty multiplier ρ is modified depending on an optimizing criterion for the inner loop.

11. The method of material flow optimization according to claim 1, wherein the system comprises a user interface, and the method includes
selecting, by an operator, a scenario from a plurality of predetermined scenarios presented by the user interface, wherein each of the predetermined scenarios include definitions of a plurality of model parameters belonging to the respective scenario, and using the model parameters for the material flow optimization;
selecting, by an operator, a filter from a plurality of predetermined filters presented by the user interface, and using the selected filter for filtering the output of the material flow optimization; and
presenting, by the user interface, an advice proposing one or more preferred actions based on the material flow optimization.

12. An integrated optimizing system for material flow optimization in an industrial process, the integrated optimizing system comprising:
a high-level optimizer module describing the material flow by coarse high-level process parameters (x) and including an optimization program for the high-level process parameters (x), the optimization program including an objective function subject to constraints and being dependent on high-level model parameters (A, b, c);
a low-level simulation module for simulating the material flow, the low-level simulation module including a low-level simulation function adapted for obtaining detailed low-level material flow data (F) based on the high-level process parameters (x); and
an aggregator module including an aggregator function adapted for calculating the high-level model parameters (A, b, c) based on the low-level material flow data (F),
wherein the integrated optimizing system is configured for approaching an optimum value of the objective function by iteratively modifying te high-level process parameters (x), wherein an iteration includes:
a) carrying out, by the low-level simulation module, a low-lever simulation thereby obtaining the detailed low-level material flow dats (F);
b) aggregating, by the aggregator module, the low-level naterial flow data (F) thereby calculating from the low-level material flow data (F), aggregated high-level model parameters (f_{A}, f_{b}, f_{c}), and
c) inputting the aggregayted high-level model parameters (f_{A}, f_{b}, f_{c}) into the optimization program.

13. The Method of material flow optimization according to claim 6, wherein
the optimization program uses, as the high-level model parameter b in expression (2), a proxy model parameter \tilde{h} iteratively approaching the aggregated high-level model parameter (f_{b}).

14. The method of claim 1, the integrated optimizing system being a computer, and the approaching the optimum value being carried out by the computer.

15. A computer program comprising instructions which, when the program is executed by a computer, causes the computer to operate as the integrated optimizing system for material flow optimization in an industrial process, the integrated optimizing system comprising:
a high-level optimizer module describing the material flow by coarse high-level process parameters (x) and including an optimization program for the high-level process parameters (x), the optimization program including an objective function subject to constraints and being dependent on high-level model parameters (A, b, c);
a low-level simulation module for simulating the material flow, the low-level simulation module including a low-level simulation function adapted for obtaining detailed low-level material flow data (F) based on the high-level process parameters (x); and
an aggregator module including an aggregator function adapted for calculating the high-level model parameters (A, b, c) based on the low-level material flow data (F),
wherein the integrated optimizing system is configured for approaching an optimum value of the objective function by iteratively modifying the high-level process parameters (x), wherein an iteration includes:
a) carrying out, by the low-level simulation module, a low-level simulation thereby obtaining the detailed low-level material flow data (F);
b) aggregating, by the aggregator module, the low-level material flow data (F) thereby calculating, from the low-level material flow data (F), aggregated high-level model parameters (f_{A}, f_{b}, f_{c}); and
c) inputting the aggregated high-level model parameters ((f_{A}, f_{b}, f_{c}) into the optimization program.

16. A computer program comprising instructions which, when the program is executed by a computer, causes the computer to carry out a method a method of material flow optimization in an industrial process by using an integrated optimizing system,
the integrated optimizing system comprising:
a high-level optimizer module describing the material flow by coarse high-level process parameters (x) and including an optimization program for the high-level process parameters (x), the optimization program being dependent on high-level model parameters (A, b, c) and including an objective function subject to constraints;
a low-level simulation module for simulating the material flow, the low-level simulation module including a low-level simulation function adapted for obtaining detailed low-level material flow data (F) based on the high-level process parameters (x); and
an aggregator module including an aggregator function adapted for calculating the high-level model parameters (A, b, c) based on the low-level material flow data (F),
the method including approaching an optimum value of the objective function by iteratively modifying the high-level process parameters (x), wherein an iteration includes:
a) carrying out, by the low-level simulation module, a low-level simulation thereby obtaining the detailed low-level material flow data (F);
b) aggregating, by the aggregator module, the low-level material flow data (F) thereby calculating, from the low-level material flow data (F), aggregated high-level model parameters ((f_{A}, f_{b}, f_{c}); and
c) inputting the aggregated high-level model parameters ((f_{A}, f_{b}, f_{c}) into the optimization program.

17. A computer-readable storage medium having stored thereon the computer program of claim 15.

18. A computer-readable storage medium having stored thereon the computer program of claim 16.
